(19) United States
(12) Patent Application Publication
(10) Pub. No.: US 2024/0165678 A1
(43) Pub. Date: May 23, 2024

(54) METHOD AND DEVICE FOR CLEANING A STORAGE RACK AND A SYSTEM AND ARRANGEMENT HAVING SUCH A DEVICE

(71) Applicant: Dematic GmbH, Heusenstamm (DE)

(72) Inventors: Max Haus, Groß-Umstadt (DE); Tsz Fung Mok, Hanau (DE)

(21) Appl. No.: 18/511,888

(22) Filed: Nov. 16, 2023

(30) Foreign Application Priority Data
Nov. 17, 2022 (DE) 102022130470.1

(51) Int. Cl. B08B 5/02; B08B 1/00; B08B 1/04; B08B 15/02

(52) U.S. Cl. CPC B08B 5/02; B08B 1/002; B08B 1/04; B08B 15/02

(57) ABSTRACT

A cleaning module device for fully automated cleaning of a storage rack, such as crossbars used for storing storage goods, has outer dimensions sized to that of a loading aid stored in the storage rack so that the device can be handled by a load handler of a storage transporter, such as a telescopic arm of a single-level rack serving apparatus configured as a shuttle. A system and an arrangement incorporate a cleaning module device and a method for cleaning a storage rack, such as crossbars used for storing storage goods is also provided.

### CROSS REFERENCE TO RELATED APPLICATION

The present application claims the priority benefits of German application no. 10 2022 130 470.1, filed on Nov. 17, 2022.

### BACKGROUND AND FIELD OF THE INVENTION

Storage racks generally become dirty after they have been installed and/or commissioned and/or after a particular period of use in a rack store. The dirt can come from the environment and can be dust for example, which is produced when building the rack store or can be carried into the rack store from the outside. However, wear debris, e.g. from rubber wheels of a rack serving apparatus, can be deposited on the storage rack.

The dirt on the storage rack and in particular on its crossbars used for storing storage goods can have negative effects. This includes, for example, the fact that the dirt accumulates on the storage goods stored in the storage rack and can contaminate same. It is also possible that the dirt covers sensors, thereby impairing the function thereof and as a result disruptions in operation can occur.

The dirt can also impair the power supply to a rack serving apparatus, in particular a single-level rack serving apparatus, if the dirt reaches a current bus used for this purpose. Moreover, dirt can be transferred from the storage rack or crossbar to a rail of the rack serving apparatus, whereby wheels used to move the rack serving apparatus can be caused to slip.

It is known that the storage rack or the crossbars of the storage rack are manually cleaned. However, this is very time-consuming and requires maintenance personnel to walk on the storage racks.

### SUMMARY OF THE INVENTION

The present invention provides a device, a system and an arrangement having such a device as well as a method which permits fully automated cleaning of a storage rack and in particular its crossbars.

In accordance with aspects of the invention, there is provided a device for fully automated cleaning of a storage rack, in particular its crossbars used for storing storage goods, where the device has outer dimensions sized to that of a loading aid, where the dimensions are at least similar, and may be identical, to those of such a loading aid stored in the storage rack so that the device can be handled by a load handler or load handling means of a rack serving apparatus configured as a storage transporter for moving goods in the storage rack, preferably a single-level rack serving apparatus, such as a shuttle.

The outer dimensions of the device—also referred to a cleaning unit or cleaning module—which are relevant for handling by the load handler of the rack serving apparatus are those which lie on the interfaces between the load handler and the device, which are also referred to as handling points. Preferably, the device can be gripped by fingers provided on the load handler of the rack serving apparatus so that the device can be moved, in particular pushed or pulled, away from and towards the rack serving apparatus.

The loading aid used as a reference and also referred to as a load carrier or storage goods carrier can be e.g. a storage container or a tray. It is also possible for the loading aid to be a pallet or lattice box. Storage goods to be stored in the storage rack or already stored therein can be arranged in such a loading aid for simpler handling thereof, e.g. by means of the rack serving apparatus. Alternatively, the storage goods can be a crate, a box, a bag and/or an individual article which is stored in the storage rack without a loading aid.

The storage rack preferably has crossbars also referred to as cross-beams or transverse members, as well as longitudinal bars also referred to as longitudinal beams or transverse ties. The crossbars and the longitudinal bars all extend horizontally in the storage rack. The storage rack also has vertically extending support pillars which are anchored in particular in a floor of a rack store. The crossbars and longitudinal bars are attached to the support pillars and extend perpendicularly thereto. The storage rack preferably comprises a plurality of rack levels which are each formed by a plurality of crossbars and a plurality of longitudinal bars. One or more crossbars and optionally one or two longitudinal bars form a storage location for the storage goods.

Owing to its outer dimensions, the device can be handled and preferably transported to any storage location of the storage rack, in addition to by means of the rack serving apparatus, also by means of other storage goods transport systems of the rack store, e.g. by means of a rack conveyor, a lift, a lift conveyor or by a so-called cross-conveyance location in the storage rack.

In addition to cleaning the crossbars, the cleaning module device in accordance with the invention can also be used to clean the longitudinal bars. In particular, when moving, in particular pushing, the device towards one of the crossbars, initially at least a partial piece of a longitudinal bar arranged between the rack serving apparatus and the crossbar is cleaned. A longitudinal bar arranged behind the crossbar, as seen from the rack serving apparatus, or a partial piece thereof can also be cleaned so long as the load handling means of the rack serving apparatus can reach this bar/piece with the device.

The device is configured such that in particular a surface of the crossbars and/or longitudinal bars facing the storage goods can be cleaned thereby.

As an alternative to the crossbars and longitudinal bars, the storage rack can also have, in addition to the vertically extending support pillars, large shelves for forming the rack levels or storage locations, wherein in that case in particular the shelves can be cleaned by means of the cleaning module device in accordance with the invention.

Cleaning of the storage rack can be effected in a fully automated manner by the cleaning module device. It is not necessary for maintenance personnel to walk on the storage racks, and therefore no corresponding safety precautions are required. Of course, the device in accordance with an aspect of the invention can also be used to perform semi-automated cleaning of the storage rack, wherein, for example, the device can be manually brought to different regions of the storage rack. In addition, the time required for cleaning the storage rack can be reduced.

In a particular embodiment, provision is made that the device comprises a fan, a dirt receptacle and a filter. In other words, the device comprises components which are suitable for drawing-in, filtering and collecting dirt. The filter is preferably functionally arranged between the dirt receptacle and the fan, in order to protect the fan from impurities in the air drawn in by the fan.

The device can comprise an outer and/or inner baffle plate, via which air drawn in by the fan and possibly containing impurities is directed into the dirt receptacle (outer baffle plate) and/or within the latter (inner baffle plate). The contour of the respective baffle plate can be designed in any manner and so a shoulder can be provided thereon for example.

For example, the fan and the filter can be arranged on such a shoulder. In addition, the respective baffle plate can be slotted. The inner baffle plate and the outer baffle plate can be connected together or form a cohesive component.

In a particular embodiment, provision is made that the device comprises a battery. In particular, the battery supplies the fan with power. However, other components of the device can also be supplied with power from the battery. The battery may provide an autonomous power supply to the device. Alternatively or in addition, the device can be supplied with power by the rack serving apparatus. In that case, in particular a corresponding connection to the device and/or to the rack serving apparatus, in particular to the load handler thereof, and a power cable for connecting to the least one connection are provided for this purpose.

In the case of the embodiment with a battery, provision can advantageously be made that the device comprises a collector (contact shoe) connected to the battery, wherein the collector can be connected to a conductor line (contact line) in order to charge the battery. The conductor line carries the electrical current which is transferred for use via the collector. The conductor line is, as described below, preferably arranged in the storage rack. However, it can also be arranged outside of the storage rack, e.g. on a warehouse floor. The collector is preferably arranged in a region of the device in which small amounts of impurity-containing air “circulate” in order for contact with the conductor line to not be disrupted by accumulations of dirt. For example, the collector can be placed in an upper section of a side wall of the device. Provision can be made that the battery is removed from the device for charging purposes, or otherwise is charged whilst remaining on the device, e.g. by connecting an external power cable to a socket provided on the device for this purpose.

Likewise, provision may be made that the device comprises at least one rotating brush and a motor for driving the at least one rotating brush. The rotating brush is used to loosen the dirt from the storage rack, in particular from the crossbars, so that the dirt can be drawn in by the fan more easily. An axis of rotation of the rotating brush extends preferably in parallel with the surface of the crossbar and/or longitudinal bar or shelf facing the storage goods. However, the axis of rotation of the rotating brush can also extend perpendicularly to the surface facing the storage goods. The rotating brush is preferably attached to a front end face of the device which reaches the storage rack first when the device moves into the storage rack. A plurality of rotating brushes can also be provided on the device, wherein in that case each of the rotating brushes in particular has its own motor. In that case, the rotating brushes are attached to the front end face and/or a rear end face opposite the front end face of the device.

Attaching a first rotating brush to the front end face and another rotating brush to the rear end face of the device has the advantage that the device can fulfil the same function irrespective of its orientation, i.e. irrespective of the side of the rack serving apparatus on which the device is moved into the storage rack. In the case of such an embodiment, the device can thus be moved into opposite storage racks and achieve the same cleaning effect therein. In addition, by way of such an attachment, dirt can be loosened so as to be drawn in more easily when moving or pushing said device into the storage rack and also when moving or pushing said device out of the storage rack. The motor of each brush can likewise be supplied with power by the battery.

In an advantageous and structurally simple manner, the device comprises an activation element, such as a limit switch, wherein the fan and/or the motor can be activated by means of the activation element and preferably is activated when the device is moved into the storage rack, in particular over a crossbar, by means of the load handler. In other words, the activation element can recognise that the device is moved, in particular pushed, into the storage rack or over a crossbar. The activation element is switched or triggered in particular at a front side of the storage rack or at a front edge of a crossbar.

The activation element can be attached to the front end face of the device so that the fan and/or the motor are already activated when the device reaches the crossbar. Alternatively or in addition, the activation element can be attached to the rear end face of the device so that the fan and/or the motor are activated when the device is already located above the crossbar. Provision can also be made that a first activation element is attached to the front end face and another activation element is attached to the rear end face of the device. In this way, the fan and/or the motor of the rotating brush can be activated irrespective of the orientation of the device, i.e. irrespective of the side of the rack serving apparatus on which the device is moved into the storage rack, in each case “at the same point in time”. The activation element can be switched or triggered mechanically (limit switch) or electrically, e.g. by a light barrier. Of course, it is possible that, in addition to the fan and/or the motor, other components of the device can be activated by the activation element.

In a particularly advantageous manner, provision is made that the device comprises a storage container, such as with components of the device are arranged on and/or in a storage container. Preferably, all the components of the device are arranged in or on the storage container. The storage container has a rectangular base surface and—as a loading aid—dimensions which enable handing with the rack serving apparatus. Preferably, an outer baffle plate is attached to a front end wall and/or a rear end wall of the storage container.

The fan, the dirt receptacle and the filter and, if provided, the battery and the collector are incorporated in particular in the storage container. The fan may be placed in the storage container by means of the inner baffle plate such that the suction force thereof can be used in an optimum manner and the fan, despite this, is sufficiently protected against drawn-in dirt.

If a rotating brush is provided, this is attached on the outside to the storage container, such as to one of the end walls of the storage container, particularly to an outer corner of the storage container. When providing a single rotating brush, this may be arranged on the front end wall of the storage container. Instead of the storage container, another loading aid, i.e. a tray, a pallet or a lattice box, can also be provided.

Provision may also be made that the dirt receptacle is formed by the storage container and the storage container has at least one opening for drawing in impurities from the storage rack, in particular from its crossbars. Other components of the device are then arranged on and/or in the dirt receptacle formed by the storage container. In a particular embodiment, a baffle plate is attached to the at least one opening which is preferably provided on the front and/or rear end wall of the storage container. The baffle plate is used to direct the drawn-in air, possibly containing impurities, into the storage container.

Provision can also be made that the device comprises two segments that can be activated in a mutually independent manner, wherein each of the two segments has its own fan and its own filter. Each segment can have its own dirt receptacle. Alternatively, both segments can also use a common dirt receptacle for collecting the drawn-in dirt. In addition, each of the segments can have a rotating brush and an associated motor. Each of the segments can have an inner baffle plate and/or an outer baffle plate. The inner baffle plate and the outer baffle plate can be connected together or form a cohesive component. A device having two segments may have just one battery that is used to supply power to both segments, in particular the fan thereof and possibly the motor thereof for the rotating brush.

The invention is further directed to a system having a rack serving apparatus, such as a single-level rack serving apparatus, and a cleaning module device, where the device can be arranged on a transport surface of the rack serving apparatus and can be moved away from the transport surface at least on one side, preferably on both sides, of the rack serving apparatus by a load handler or load handling means of the rack serving apparatus, which preferably comprises at least one telescopic arm that extends and retracts from the rack serving apparatus, such as a shuttle for placing goods into and removing goods from a storage rack. The device can thus be moved away from the transport surface of the rack serving apparatus transversely to a direction of travel of the rack serving apparatus. The load handler used for this purpose comprises, in particular, fingers, by means of which the cleaning module device can be moved, in particular pushed, from the transport surface onto or into the storage rack.

The single-level rack serving apparatus, also referred to as a shuttle, may serve only one individual rack level of the storage rack, but can also be configured such that it serves a few, such as two or three, rack levels. The single-level rack serving apparatus can be moved on two rails along a rack aisle between two adjacent and parallel storage racks. The rails are provided in a rack level associated with the single-level rack serving apparatus. In each case, a rail is attached to one of, or part of one of, the opposite storage racks separated by the rack aisle. The single-level rack serving apparatus can switch between rack levels via a lift optionally provided in the storage rack.

The single-level rack serving apparatus is connected to a controller for the transmission of control commands, which is effected in particular by means of conductor lines. The single-level rack serving apparatus can be supplied with power in particular likewise by means of conductor lines.

The single-level rack serving apparatus can deliver storage goods into the storage rack, or pick up storage goods therefrom, using its load handler, preferably on both sides of the rack aisle, and so this apparatus can move the device, preferably on both sides, into and out of the storage rack, i.e. in particular can push the device into, and pull the device out of, the storage rack.

The single-level rack serving apparatus can preferably bring the device to all the storage locations of the respective rack levels to which it is allocated. Storage locations in the other rack levels of the storage rack or, if a plurality of single-level rack serving apparatuses serve one rack level, in the other regions of the rack levels can be cleaned by one or more other single-level rack serving apparatuses. Provision can be made to transfer from one single-level rack serving apparatus to another single-level rack serving apparatus, e.g. using a transfer location on the storage rack.

The rack serving apparatus can also be a transporter configured as a multi-level rack serving apparatus which, in contrast to the previously described embodiment of the rack serving apparatus, serves many, in particular more than three, or all of the rack levels of a storage rack. The multi-level rack serving apparatus can also serve a plurality of storage racks, e.g. adjacent storage racks in one rack aisle or storage racks arranged in a plurality of rack aisles. The multi-level rack serving apparatus, also referred to as a stacker crane or storage and retrieval unit, is a single-lane, rail-guided vehicle and comprises a lower running gear unit, at least one mast and a lifting carriage, which can be moved on the mast, with a load handling means. The multi-level rack serving apparatus has, in addition to the lower running gear unit, optionally an upper running gear unit which is arranged on an end of the mast remote from the lower running gear unit. The multi-level rack serving apparatus can be guided e.g. on a head cross beam via guide rollers provided on the upper running gear unit. The multi-level rack serving apparatus can include other components, such as e.g. a lifting mechanism having a cable or chain drive, ladders and power supplies.

The multi-level rack serving apparatus can be moved in three spatial directions or axes. The lower running gear unit, in particular with the running wheels provided thereon, is used to move the multi-level rack serving apparatus along a rail which is arranged in particular in a rack aisle. The mast arranged on the lower running gear unit and arranged substantially vertically to the rail is used to lift and lower the lifting carriage along the mast. The load handling means of the lifting carriage can be moved substantially vertically to the rail and substantially vertically to the mast, i.e. transversely to a direction of travel of the multi-level rack serving apparatus and is also used to pick up and deliver the storage goods.

The multi-level rack serving apparatus can likewise deliver storage goods into the storage rack, or pick up goods therefrom, using its load handler or handling means, preferably on both sides of the rack aisle, and so this apparatus can move the device, preferably on both sides, into and out of the storage rack, i.e. in particular it can push the device into, and pull the device out of, the storage rack.

The multi-level rack serving apparatus can be used to bring the cleaning module device in many or all rack levels to the storage locations provided therein. If a plurality of multi-level rack serving apparatuses are to use the same device for cleaning the storage racks, provision can be made to transfer the device from one multi-level rack serving apparatus to another multi-level rack serving apparatus, e.g. using a transfer location on the storage rack.

Of course, both forms of the rack serving apparatus can be used in the rack store. In the case of such a mixed use scenario, it is feasible that the device can be transferred, in particular by means of a transfer location in the storage rack, from a single-level rack serving apparatus to a multi-level rack serving apparatus or vice versa.

Provision is also provided that a brush is attached to the load handler of the transporter, such as to the at least one telescopic arm. The brush attached to the load handler is then provided in addition to the device and is preferably rigid, i.e. non-rotating. The brush can be moved away from and towards the rack serving apparatus by means of the load handler in order to sweep the dirt lying on the storage rack and/or to loosen stuck-on dirt, which is then removed by the device. The brush may be arranged on the load handler such that this can be moved away from the rack serving apparatus in equal measure on both sides of the rack serving apparatus.

Owing to such a brush, for example a speed at which the cleaning module device is moved over the crossbar and/or longitudinal bar or shelf can be reduced. Also, the device does not need to be moved multiple times over the crossbar and/or longitudinal bar or shelf. Provision is also made that the load handler comprises two mutually parallel telescopic arms, in which case the brush may be arranged between, and attached to, the telescopic arms.

In a particular embodiment the brush is preferably arranged on a free end of the telescopic arms and preferably extends perpendicularly to a retraction and extension direction of the telescopic arms. This brush is thus arranged, in the extension direction, in front of the device located between the two telescopic arms so that it can be used to “pre-clean”the crossbar and/or longitudinal bar or shelf. The brush may be elongate, i.e. its width extending in the retraction and extension direction is considerably smaller than its length extending perpendicularly to the retraction and extension direction. In this embodiment, the brush can be used to push dirt away from the rack serving apparatus into a rear region of the storage rack or pushed from under the storage rack at the rear.

The rack serving apparatus having the brush attached to the load handler and arranged between two telescopic arms forming the load handling means can also be used without a cleaning module device.

The invention is further directed to an arrangement having a system in accordance with the invention and a storage rack which has a plurality of crossbars for storing storage goods, wherein the device can be moved along the crossbars by means of the load handling means of the rack serving apparatus. In other words, the crossbars are arranged in the storage rack such that the load handler of the transporter or rack serving apparatus can be extended and retracted parallel thereto in order to move the device along the crossbars. The device can be moved along the entire extension length of the crossbars. A width of the crossbar can be equal to, less than or greater than a width of the device and/or length of the brush attached to the load handling means.

If the device has a rotating brush, the axis of rotation thereof may extend parallel to or perpendicularly to the surface of the crossbar or longitudinal bar or shelf facing the storage goods, which surface is the one being cleaned by means of the device.

Provision is advantageously made that the device is operated by a battery and the storage rack has a charging position in which the device can be positioned in order to charge the battery. In other words, the device can be temporarily stored in the storage rack in order to charge the battery. The charging position is configured such that the device can be positioned in an automated manner. A power connection required for charging the battery can then be established simply by handling by means of the rack serving apparatus and thus without human intervention. The charging position can also be utilised for other purposes, e.g. as the transfer location for transfer between two rack serving apparatuses.

Provision can advantageously be made that a conductor line is provided at the charging position, to which the collector of the device can be connected. The conductor line, by means of which the battery connected to the collector can be charged, may be attached to a support pillar of the storage rack. In this way, the conductor line can be arranged at a height which allows attachment of the collector in a region, in particular an upper region, of the device in which comparatively small amounts of drawn-in and possibly dirty air “circulate”. Alternatively, the conductor line can be attached to a support element provided specifically for this purpose, i.e. one that is independent of the storage rack. For example, the conductor line can be positioned, when using such a support element, in the storage rack such that the collector can be attached to the front and/or rear end face of the device. Connection or contact between the collector and the conductor line is established in particular by virtue of the fact that the device is moved, in particular pushed, into the charging position by means of the rack serving apparatus and is thereby positioned at the conductor line.

The invention also relates to a method for cleaning a storage rack, in particular its crossbars used for storing storage goods, wherein the storage rack is cleaned by means of a cleaning module device, wherein the device is moved on a transport surface of a rack serving apparatus along the storage rack and is moved, by a load handler of the rack serving apparatus, into the storage rack, in particular along the crossbars, in order to clean the storage rack and in particular the crossbars. In other words, the device is moved back and forth by the load handler in the storage rack and preferably along the surface of the crossbar or longitudinal bar or shelf facing the storage goods. This process can be repeated as often as required in order to achieve the desired cleaning result. Then, the device is moved back onto the transport surface of the rack serving apparatus by the load handler. In a next step, the rack serving apparatus is moved along the storage rack, such as to an adjacent crossbar.

Alternatively, the rack serving apparatus can be moved a distance corresponding to the width of the device. This is particularly effected when the width of the device is smaller than the width of the crossbar or is a multiple of the width of the crossbar or a shelf is cleaned. Then, the device is moved by the load handler onto this crossbar or this section of the shelf.

Preferably, the crossbar is cleaned along its entire extension length and the entire depth of the shelf is cleaned. However, it may be that only partial pieces of the crossbar or shelf are cleaned. The rack serving apparatus used may have a brush attached to its load handler, where the method makes provision for the dirt captured by the brush to be pushed beneath a rear side of the storage rack. The method is performed via or by a controller of the rack serving apparatus or a superordinate controller of the rack store.

Provision is also made that the device comprises two segments and the segments can be activated in a mutually independent manner, wherein a first segment is activated when the device is moved into the storage rack and a second segment is activated when the device is moved out of the storage rack.

Further details of the invention will become clear from the following description of exemplified embodiments by reference to the drawings.

### BRIEF DESCRIPTION OF THE DRAWINGS

FIG. 1 shows a schematic perspective view of an embodiment of the device in accordance with the invention;

FIG. 2 shows a schematic perspective sectional view of the device of FIG. 1;

FIG. 3 shows a schematic perspective view of another embodiment of the device in accordance with the invention;

FIG. 4 shows a schematic sectional view of the device of FIG. 3;

FIG. 5 shows a schematic perspective view of a segment for use in the device of FIGS. 3 and 4;

FIG. 6 shows a schematic sectional view of the segment of FIG. 5;

FIG. 7 shows a schematic perspective view of a single-level rack serving apparatus having two brushes attached to its load handling means; and

FIG. 8 shows a schematic perspective view of an arrangement having a single-level rack serving apparatus of FIG. 7.

### DETAILED DESCRIPTION

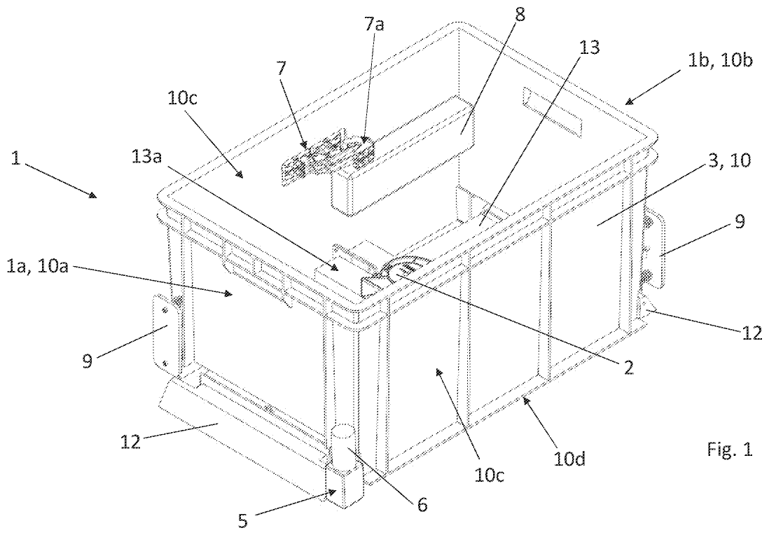

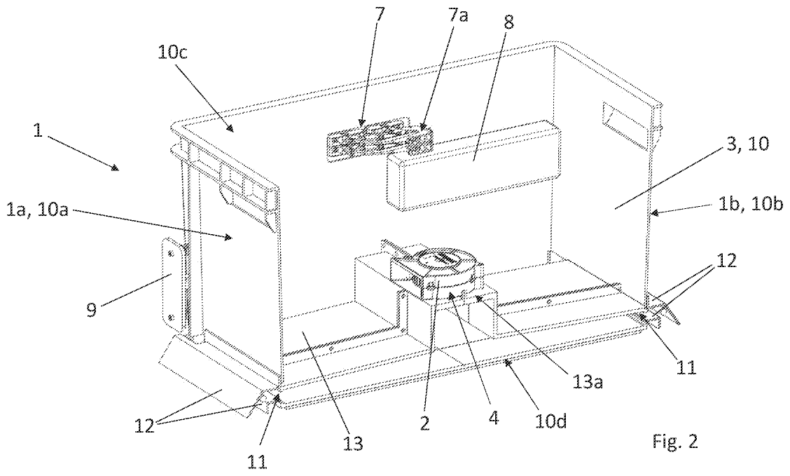

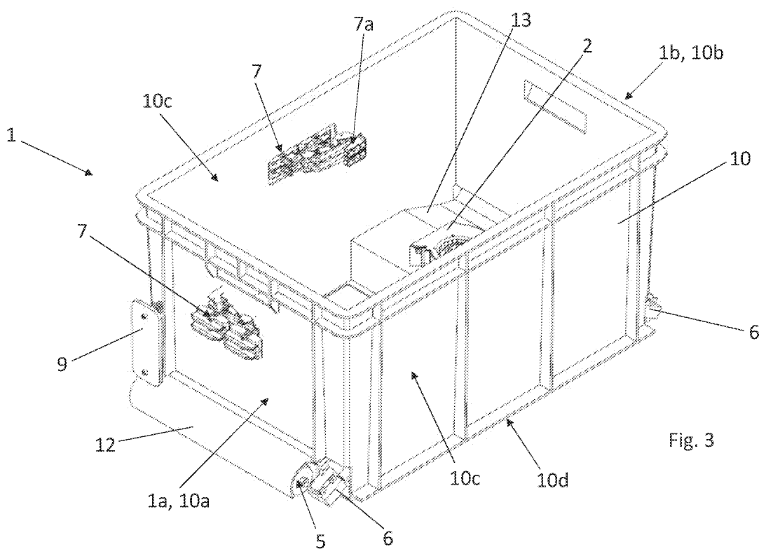

FIG. 1 shows a schematic perspective view of an embodiment of the cleaning unit or cleaning module device 1 in accordance with an embodiment of the invention. The device 1 which is provided for fully automated cleaning of a storage rack 100, including its crossbars 101 and/or longitudinal bars 102 (see FIG. 3) or shelves, comprises a fan 2 (see FIG. 2), a dirt receptacle 3 and a filter 4 (see FIG. 2). In the illustrated embodiment, the dirt receptacle 3 of the device 1 is formed by a storage container 10. The fan 2 and the filter 4 are arranged in the storage container 10 and thus in the dirt receptacle 3. The storage container 10 is a loading aid and can thus be handled by a load handler of a rack serving apparatus despite the changes to the loading aid necessary for the functionality of the device 1. The dimensions of the storage container 10 relevant for this have specifically been retained.

In the illustrated embodiment, the cleaning module device 1 has a battery 8 and a collector 7 connected thereto via an electrical connection 7a. The collector 7 is provided in order to charge the battery of the device 1 via a conductor line which is arranged for example at a charging position in a storage rack 100. The battery 8 and the collector 7 are likewise arranged in the storage container 10 and thus in the dirt receptacle 3. In order to avoid accumulations of dirt on the collector 7, this is attached in an upper region of a side wall 10c of the storage container 10 where small amounts of impurity-containing air “circulate”.

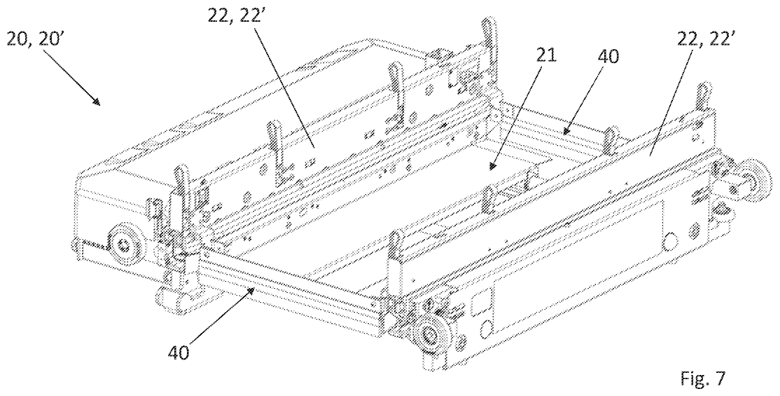

A rotating brush 5 is attached to a front end face 1a of the device 1, which, in the embodiment illustrated here, is formed by a front end wall 10a of the storage container 10. The rotating brush 5 is driven via a motor 6 arranged above the brush 5. The motor 6 is supplied with power by the battery 8. An electrical connection 7a used for this purpose is not illustrated. An axis of rotation of the rotating brush 5 extends perpendicularly to a base 10d of the storage container 10 and thus also perpendicularly to a surface of a crossbar 101 (see FIG. 7) and/or longitudinal bar 102 or shelf of the storage rack 100, said surface facing the storage goods. It is possible that other rotating brushes 5 are provided on the device 1.

Outer baffle plates 12 are provided on the front end wall 10a and on a rear end face 1b of the device 1, which, in the embodiment illustrated here, is formed by a rear end wall 10b of the storage container 10. These outer baffle plates 12 are used to direct the air drawn in by the fan 2 into the storage container 10.

The device 1 additionally comprises a limit switch 9 which is arranged in the region of the front end wall 10a of the storage container 10. The fan 2 and the motor 6 can be activated by this limit switch 9. Activation is effected in particular when the device 1 is moved into the storage rack 100 and the limit switch 9 is switched or triggered.

FIG. 2 shows a schematic perspective sectional view of the device 1 of FIG. 1. This view clearly shows how the outer baffle plates 12 are configured and arranged. Two outer baffle plates 12 are arranged in each case on the front end wall 10a and on the rear end wall 10b of the storage container 10, wherein the drawn-in air is directed between the two outer baffle plates 12 through the opening 11 into the storage container 10. An inner baffle plate 13 is provided in the interior of the storage container 10 and in the present case is a separate component from the outer baffle plate 12. The air drawn in by the fan 2 and directed into the storage container 10 by means of the outer baffle plates 12 is directed within the storage container 10 via the inner baffle plate 13.

This view also clearly shows how the fan 2 and the filter 4 are arranged in the storage container 10. The fan 2 is arranged on a shoulder 13a formed by the inner baffle plate 13. The filter 4 is arranged between the fan 2 and the inner baffle plate 13.

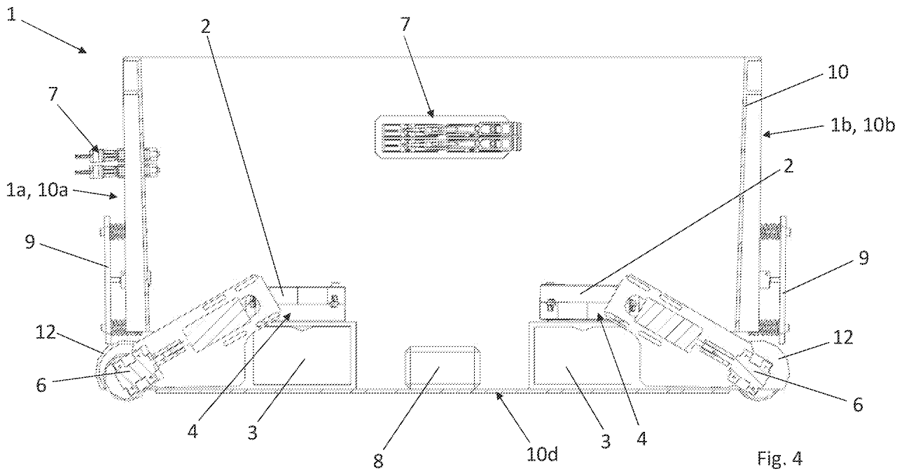

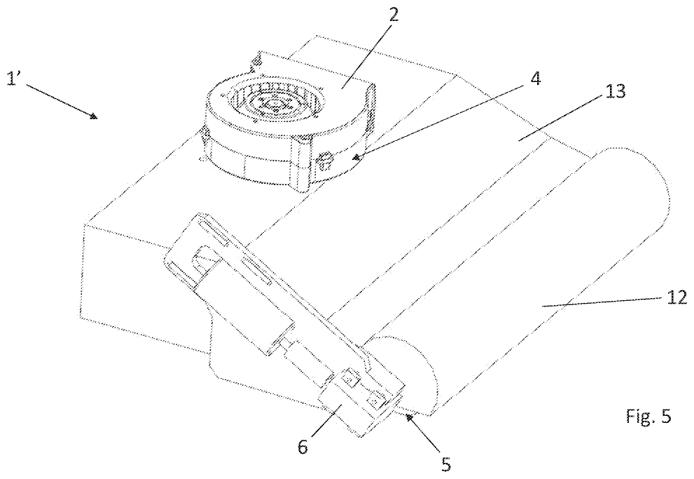

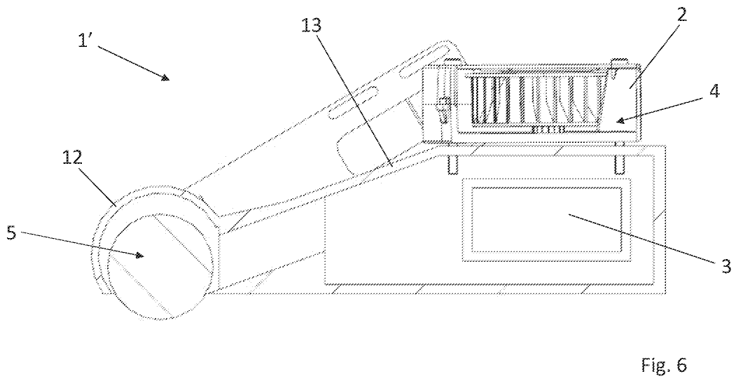

FIG. 3 shows a schematic perspective view of another embodiment of the device 1 in accordance with the invention. FIG. 4 shows a schematic sectional view of the device 1 of FIG. 3. As per the embodiment shown in FIGS. 1 and 2, the components of the device 1 are arranged on and in a storage container 10. However, in this embodiment, the device 1 has two segments 1′ (see also FIGS. 5 and 6) which can be activated in a mutually independent manner. For example, provision can be made that one of the two segments 1′ is activated when the device 1 is moved into the storage rack 100 and a second segment 1′ is activated when the device 1 is moved out of the storage rack 100.

Each of the two segments 1′ includes its own fan 2 and its own filter 4. In addition, each of the two segments 1′ in the present case has a rotating brush 5 which is positioned in each case such that it protrudes out of the storage container 10. The axis of rotation of the rotating brush 5 extends parallel to the base 10d of the storage container 10 and thus also parallel to a surface of a crossbar 101 (see FIG. 7) and/or longitudinal bar 102 or shelf of the storage rack 100, said surface facing the storage goods. Each rotating brush 5 has a motor 6 which is likewise arranged on and attached to the segment 1′.

Each of the segments 1′ has its own dirt receptacle 3. Alternatively, both segments 1′ can also use a common dirt receptacle 3 for collecting the drawn-in dirt. Each of the two segments 1′ also has an inner baffle plate 13 and an outer baffle plate 12. The inner baffle plate 13 and the outer baffle plate 12 form, in the present case, a cohesive component which extends away from the dirt receptacle 3 (see also FIGS. 5 and 6). The two segments 1′ are formed to be approximately identical. Only the motor 6 for the rotating brush 5 is arranged on another side of the segment 1′. FIG. 4 clearly shows how the two segments 1′ are arranged in the storage container 10.

In the illustrated embodiment, the device 1 has a single battery 8 which is arranged between the two segments 1′ on the base 10d of the container 10. The battery 8 is used for supplying power to both segments 1′, in particular the fan 2 thereof and motor 6 thereof for the rotating brush 5.

In the illustrated embodiment, two collectors 7 are provided for charging the battery 8. One of the collectors 7 is arranged on the front end face 1a of the device 1 or on the front end wall 10a of the storage container 10. The other collector 7 is attached to a side wall 10c of the storage container 10.

The device 1 also has two limit switches 9, wherein one of the limit switches 9—as illustrated—is arranged on and attached to the front end face 1a of the device 1 or front end wall 10a of the storage container 10. The other limit switch 9 is arranged on and attached to the rear end face 1b of the device 1 or the rear end wall 10b of the storage container 10. In this way, the fan 2 and the motor 6 of the rotating brush 5 can be activated irrespective of the orientation of the device 1, i.e. for example irrespective of the side of the rack serving apparatus 20 on which the device 1 is moved into the storage rack 100, in each case “at the same point in time”.

It is possible that the device 1 only has one of the two segments 1′. It is also possible that the device 1 has a segment 1′ formed in an alternative manner, in which for example only the fan 2 and the filter 4 are provided.

FIG. 5 shows a schematic perspective view of a segment 1′ for use in the device 1 of FIGS. 3 and 4. FIG. 6 shows a schematic sectional view of the segment 1′ of FIG. 5. The segment 1′ has a fan 2, a filter 4, a rotating brush 5, a motor 6 for the rotating brush 5, an outer baffle plate 12, an inner baffle plate 13 and a dirt receptacle 3. In the present case, the dirt receptacle 3 is thus provided on the segment 1′. Alternatively, the dirt receptacle 3 can also be formed outside of the segment 1′, e.g. by the storage container 10, as is the case in the embodiment illustrated in FIGS. 1 and 2.

The fan 2 and the filter 4 are arranged on the dirt receptacle 3. In the present case, the inner baffle plate 13 of the segment 1′ extends away from the dirt receptacle 3 and transitions into the outer baffle plate 2. In the present case, the outer baffle plate 12 and the inner baffle plate 13 form a cohesive component, but can also be two mutually independent components. The motor 6 of the rotating brush 5 is attached to the cohesive component consisting of the inner baffle plate 13 and the outer baffle plate 12. The rotating brush 5 is mounted on the outer baffle plate 12 and is “straddled” thereby.

FIG. 7 shows a schematic perspective view of a single-level rack serving apparatus 20′ comprising a transporter configured as a shuttle having two brushes 40 attached to its load handler or load handling means 22. In the present case, the load handler or handling means 22 of the single-level rack serving apparatus 20′ is formed by two mutually parallel telescopic arms 22′. Each of the two brushes 40 is arranged between, and attached to, these two telescopic arms 22′. Each of the brushes 40 is elongate and is arranged at a free end of the telescopic arms 22′. The brush 40 extends in each case transversely with respect to a retraction and extension direction of the telescopic arms 22′. The two brushes 40 are arranged on opposite free ends of the telescopic arms 22′.

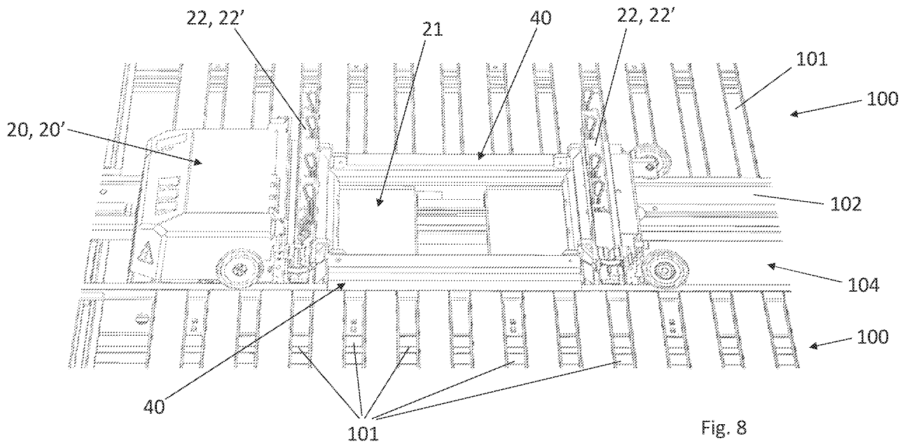

The single-level rack serving apparatus 20′ additionally comprises a transport surface 21. The device 1 can be transported on the transport surface 21 along the storage rack 100 (see FIG. 8). The device 1, not illustrated in this figure, is then arranged between the two telescopic arms 22′ and can be moved thereby into the storage rack 100 on both sides of the single-level rack serving apparatus 20′.

FIG. 8 shows a schematic perspective view of an arrangement having a single-level rack serving apparatus 20′ of FIG. 7. In addition to the single-level rack serving apparatus 20′, the arrangement comprises two mutually parallel storage racks 100. The single-level rack serving apparatus 20′ can be moved on two rails along a rack aisle 104 extending between the two storage racks 100. Each of the rails is attached to one of the two storage racks 100. This figure illustrates one rack level of each of the storage racks 100 which is served by the single-level rack serving apparatus 20′. The rack level is formed by longitudinal bars 102 and crossbars 101. The storage rack additionally comprises support pillars 103 which are not illustrated in the present case.

The device 1 (not illustrated) can be transported on the transport surface 21 of the single-level rack serving apparatus 20′ along the storage rack 100. The device 1 can be moved into the storage rack 100 with the two telescopic arms 22′ on both sides of the single-level rack serving apparatus 20′.

The brush 40 is arranged transversely to the crossbars 101 of the storage rack 100 and in the present case has a length such that it extends over five crossbars 101. As seen in the extension direction of the telescopic arms 22′, the brush 40 is arranged in front of the device 1 which can be handled by the telescopic arms 22′ so that it loosens the dirt for drawing-in by the device 1 and can sweep the dirt away from the crossbars 101.

Changes and modifications in the specifically described embodiments can be carried out without departing from the principles of the present invention which is intended to be limited only by the scope of the appended claims, as interpreted according to the principles of patent law including the doctrine of equivalents. The priority German application no. DE 10 2022 130 470.1, filed Nov. 17, 2022, is hereby incorporated by reference, in particular for support with regard to the translation for the present disclosure.

1. A storage rack cleaning device for fully automated cleaning of a storage rack used for storing storage goods, wherein the cleaning device has outer dimensions sized to those of a loading aid stored in the storage rack such that the cleaning device can be handled by a load handler of a rack serving apparatus configured to place goods into and remove goods from the storage rack.

2. The storage rack cleaning device as claimed in claim 1, wherein the cleaning device comprises a fan, a dirt receptacle and a filter.

3. The storage rack cleaning device as claimed in claim 2, further comprising a battery.

4. The storage rack cleaning device as claimed in claim 3, further comprising a collector connected to the battery, and wherein the collector can be connected to a conductor line in order to charge the battery.

5. The storage rack cleaning device as claimed in claim 1, wherein the cleaning device comprises at least one rotating brush and a motor for driving the at least one rotating brush.

6. The storage rack cleaning device as claimed in claim 2, further comprising an activation switch, wherein the fan and/or the motor are selectively activated by the switch when the device is moved into the storage rack by the load handler.

7. The storage rack cleaning device as claimed in claim 6, wherein the switch is configured to be activated when the device is moved over a crossbar of the storage rack.

8. The storage rack cleaning device as claimed in claim 1, wherein components of the cleaning device are integrated on and/or in a storage container.

9. The storage rack cleaning device as claimed in claim 8, wherein a dirt receptacle is formed by the storage container and the storage container has at least one opening for drawing in impurities from the storage rack.

10. The storage rack cleaning device as claimed in claim 2, wherein the cleaning device comprises two segments that can be activated in a mutually independent manner, wherein each of the two segments has its own fan and its own filter.

11. The storage rack cleansing device of claim 1, wherein the rack serving apparatus comprises a shuttle and the load handler of the shuttle comprises at least one telescopic arm.

12. A system having a rack serving apparatus and a storage rack cleaning device as claimed in claim 1, wherein the rack serving apparatus includes a transport surface on which the cleaning device can be arranged, and wherein the cleaning device can be moved away from the transport surface from at least on one side of the rack serving apparatus by the load handler of the rack serving apparatus.

13. The system as claimed in claim 12, wherein the load handler comprises at least one telescopic arm and wherein a brush is attached to the load handler.

14. The system as claimed in claim 13, wherein the load handler comprises two mutually parallel telescopic arms and wherein the brush is arranged between, and attached to, the telescopic arms.

15. An arrangement having a system as claimed in claim 12 and a storage rack that has a plurality of crossbars for storing storage goods, wherein the storage rack cleaning device can be moved along the crossbars by the load handler of the rack serving apparatus.

16. The arrangement as claimed in claim 15, wherein the cleaning device is operated by a battery and the storage rack has a charging position in which the cleaning device can be positioned in order to charge the battery.

17. The arrangement as claimed in claim 16, wherein a conductor line is provided at the charging position to which the collector of the cleaning device can be connected.

18. A method for cleaning a storage rack using a storage rack cleaning device, where the storage rack includes crossbars and a rack serving apparatus configured to place goods into and remove goods from the storage rack, said method comprising:
providing a storage rack cleaning device in the storage rack, wherein the cleaning device has outer dimensions sized to those of a loading aid stored in the storage rack such that the cleaning device can be handled by a load handler of the rack serving apparatus;
moving the cleaning device along the storage rack on a transport surface of the rack serving apparatus;
moving the cleaning device from the rack serving apparatus into the storage rack by the load handler of the rack serving apparatus; and
cleaning the storage rack with the cleaning device, wherein said cleaning the storage rack comprises cleaning crossbars of the storage rack.

19. The method as claimed in claim 18, wherein the cleaning device comprises two segments, and wherein each segment can be activated in a mutually independent manner, and wherein a first segment is activated when the cleaning device is moved into the storage rack and a second segment is activated when the device is moved out of the storage rack.
